(19) United States
(12) Patent Application Publication
(10) Pub. No.: US 2023/0061196 A1
(43) Pub. Date: Mar. 2, 2023

(54) WOOD CHIPPER AND SYSTEM AND METHOD FOR DISCHARGE

(71) Applicant: Tigercat Industries Inc., Brantford (CA)

(72) Inventor: Anders RAGNARSSON, Chester, NH (US)

(21) Appl. No.: 17/883,996

(22) Filed: Aug. 9, 2022

Related U.S. Application Data
(60) Provisional application No. 63/231,011, filed on Aug. 9, 2021.

(51) Int. Cl. B02C 18/22; B02C 23/24; B02C 21/02

(52) U.S. Cl. CPC B02C 18/2216; B02C 23/24; B02C 21/02

(57) ABSTRACT

A wood chipper including: a base frame; an engine provided to the base frame; a reduction chamber provided to the base frame, the reduction chamber comprising a rotor, a reduction chamber input and a reduction chamber output, wherein the rotor is driven by the engine; a feeder input configured to provide input material to the reduction chamber input; a discharge chamber provided in communication with the reduction chamber output; a fan configured to draw air and comminuted material through the discharge chamber away from the reduction chamber and push the comminuted material out of the fan.

### FEILD

The present disclosure relates generally to wood chippers, sometimes called wood grinders or wood shredders. More particularly, the present disclosure relates to a system and method for discharge from a wood chipper.

### BACKGROUND

Wood chippers, sometimes called wood shredders, wood grinders, or comminuting machines, typically reduce wood product, such as trees, branches, stumps, for example, to a desired chip or particle size. Wood chippers have conventionally been very large, mostly stationary machines that can handle larger wood products, trees, branches and the like or smaller, portable machines that can be moved to a location but can generally only handle smaller wood products, trees, branches and the like.

A wood chipper generally includes a reduction chamber which has an impact rotor located concentrically therein, in combination with a surrounding housing, a drive motor driving the rotor and an infeed chute for supplying material to be reduced. The rotor has a plurality of impact strikers secured to its exterior surface. The rotor is positioned so that the log, tree, debris, wood product, stump, etc., to be comminuted, is fed into the reduction chamber and directed against the strikers, and pushed in the rotor's rotational direction against an anvil which is located along either the top or the bottom of the reduction chamber, depending upon the rotational direction of the rotor. The reduced/chipped material is then removed from the chipper via a discharge such as a belt conveyor or the like.

Conventional wood chippers, particularly larger units or units with rotors moving at lower revolutions per minute (RPM), can have difficulties in discharging the chips rapidly enough to keep up with the input wood products in order to keep the reduction chamber clear. As such, there is a need for an improved wood chipper with an improved system and method for discharging chips.

The above information is presented as background information only to assist with an understanding of the present disclosure. No determination has been made, and no assertion is made, as to whether any of the above might be applicable as prior art with regard to the present disclosure.

### SUMMARY

In a first aspect, there is provided a wood chipper including: a base frame; an engine provided to the base frame; a reduction chamber provided to the base frame, the reduction chamber comprising a rotor, a reduction chamber input and a reduction chamber output, wherein the rotor is driven by the engine; a feeder input configured to provide input material to the reduction chamber input; a discharge chamber provided in communication with the reduction chamber output; a fan configured to draw air and comminuted material through the discharge chamber away from the reduction chamber and push the comminuted material out of the fan.

In some cases, the wood chipper may include a discharge chute in communication with the fan to receive the comminuted material and discharge the comminuted material away from the wood chipper.

In some cases, the discharge chamber may have an elliptical cross-section and be divided into a first section in which comminuted material is drawn upward and a second section where the comminuted material is drawn downward toward an exit from the discharge chamber. In some cases, the first section and second section are separated by a sloped interior wall that directs the comminuted material upward and into the second section. Further, in some cases, the second section may include a sloped wall that directs the comminuted material toward a side of the discharge chamber and toward the exit from the discharge chamber.

In some cases, the fan may include a plurality of blades configured to draw air and comminuted material through the discharge chamber away from the reduction chamber and push the comminuted material out of the fan. In particular, the fan and plurality of blades can be configured to achieve a predetermined pressure for a flow of comminuted material.

Other aspects and features of the present disclosure will become apparent to those ordinarily skilled in the art upon review of the following description of specific embodiments in conjunction with the accompanying figures.

### BRIEF DESCRIPTION OF THE FIGURES

Embodiments of the present disclosure will now be described, by way of example only, with reference to the attached Figures.

FIG. 1 is a front perspective view of a wood chipper according to an embodiment herein;

FIG. 2 is a back perspective view of the wood chipper of FIG. 1;

FIG. 3 is a front perspective view of the wood chipper of FIG. 1 showing detail of a discharge chamber;

FIG. 4 is a rear perspective view showing detail of the discharge chamber;

FIG. 5 is a front perspective view showing interior detail of the discharge chamber;

FIG. 6 is a front perspective view showing interior detail of a fan and discharge chute of the wood chipper of FIG. 1;

FIG. 7 is a rear perspective view showing interior detail of a fan and discharge chute of the wood chipper of FIG. 1; and

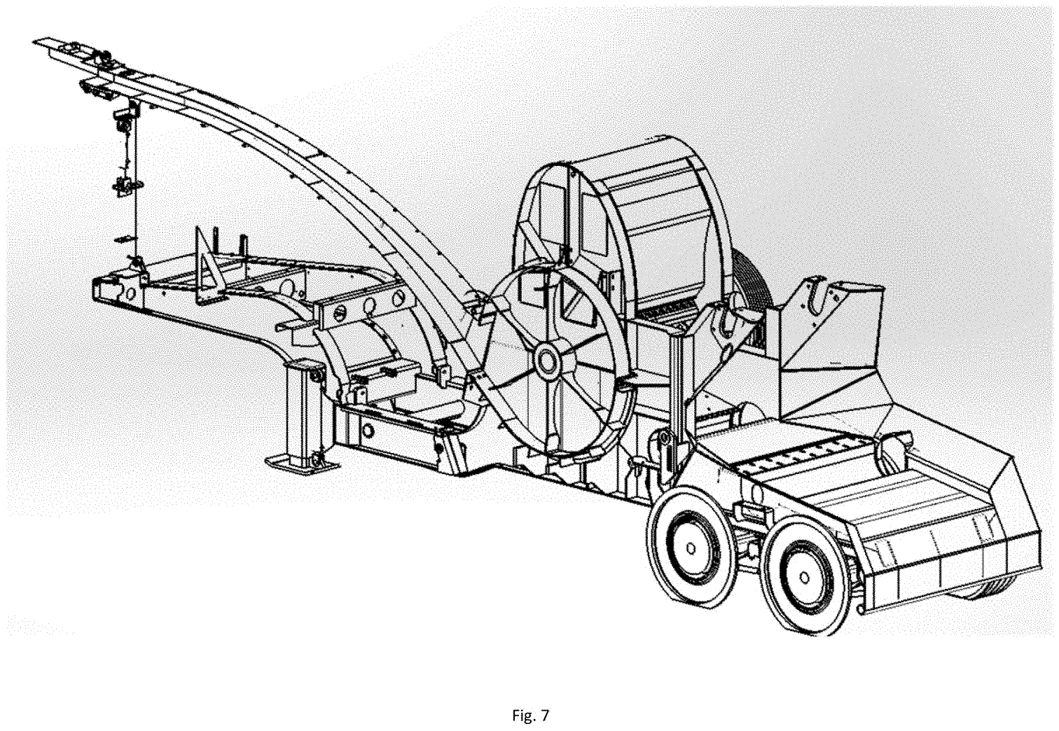

FIG. 8 is a rear cut-away view showing interior detail of the reduction chamber and the discharge chamber.

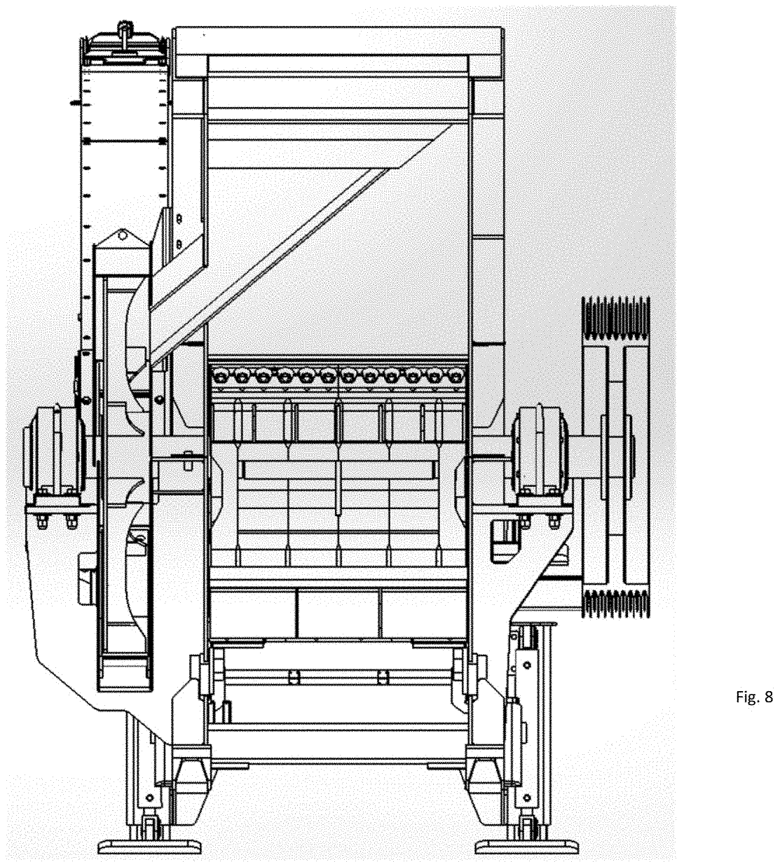

### DETAILED DESCRIPTION

In the following, various example systems and methods will be described herein to provide example embodiment(s). It will be understood that no embodiment described below is intended to limit any claimed invention. The claims are not limited to systems, apparatuses or methods having all of the features of any one embodiment or to features common to multiple or all of the embodiments described herein. A claim may include features taken from any embodiment as would be understood by one of skill in the art. The applicants, inventors or owners reserve all rights that they may have in any invention disclosed herein, for example the right to claim such an invention in a continuing or divisional application and do not intend to abandon, disclaim or dedicate to the public any such invention by its disclosure in this document.

Generally, the present disclosure provides a wood chipper with an improved system and method for discharge of the output (wood chips).

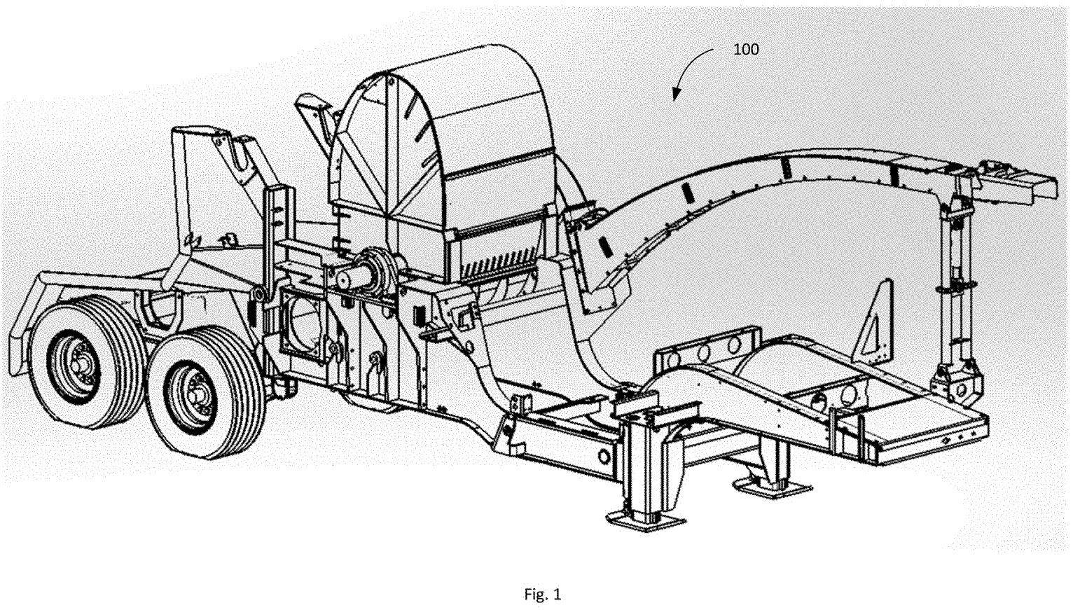

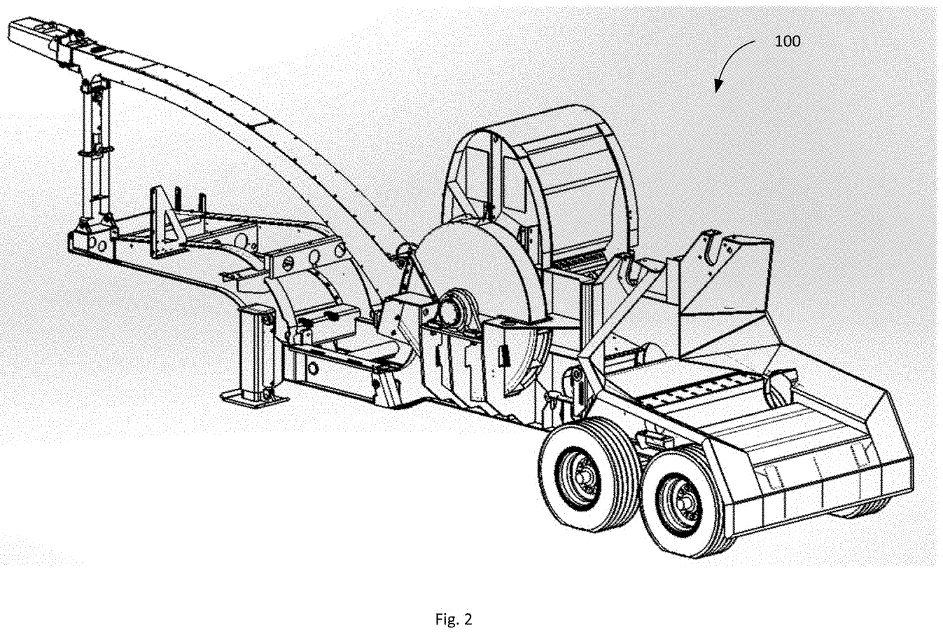

FIG. 1 and FIG. 2 show front and rear perspective views of a wood chipper 100 according to an embodiment herein. In FIGS. 1 and 2, various components have been removed to better illustrate the components that are the focus of this description. In this embodiment, the wood chipper 100 is designed to be portable and can be transported to a desired location or site in order to facilitate comminution of various feed materials. Feed materials can include various types of wood products, including forestry debris, vegetative debris, trees, bark, stumps and the like.

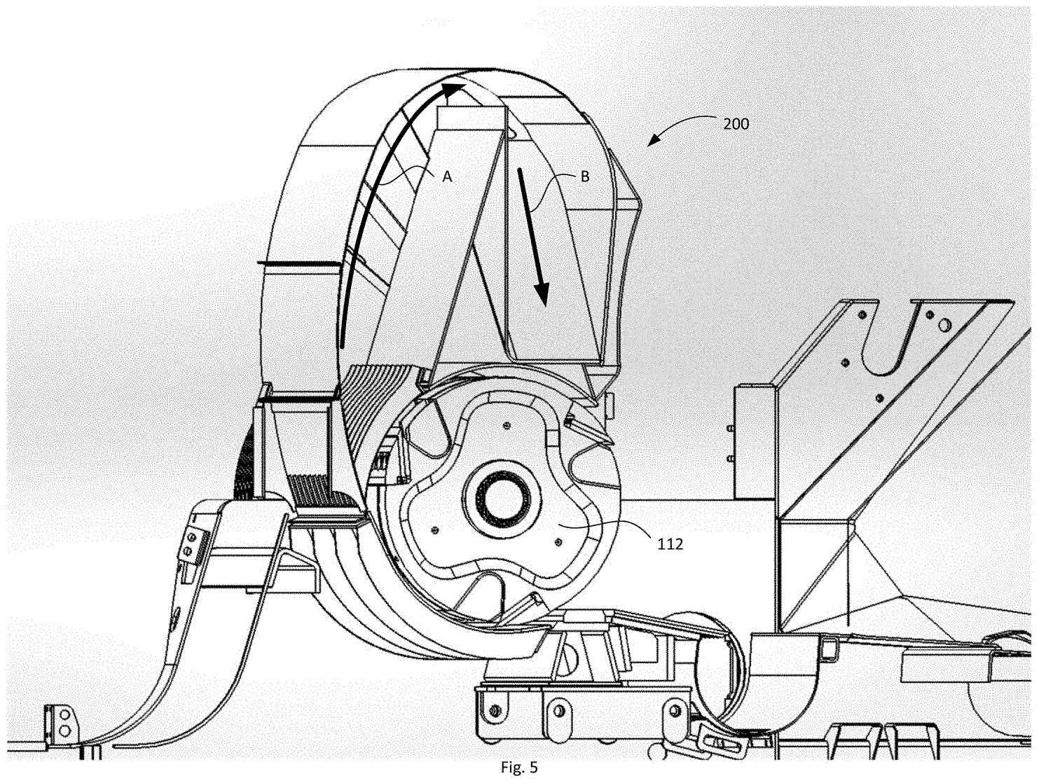

The wood chipper 100 includes a base frame 105 upon which the various components of the wood chipper are assembled. An engine (not shown), e.g., a diesel powered engine, is supported on the base frame 105, to connect to a shaft 110 of a rotor 112 (shown in FIG. 5). In some cases, the engine may also drive a hydraulic pump (not shown) which pumps hydraulic fluid and thus generates a source of hydraulic pressure for controlling various other operations of the wood chipper 100.

The wood chipper 100 includes wheels 120 attached to the base frame 105 for allowing movement of the wood chipper 100 when connected to a truck or the like, Alternatively, the wood chipper may have a drive track assembly or the like.

As generally shown in FIG. 2, the wood chipper 100 includes a feed input area 115 on the base frame 105 that assists with feeding feed material toward the rotor 112. The rotor 112 is housed in a reduction chamber 114 (shown in FIG. 5). The feed input 115 may include a conveyor or the like. In some cases, the feed input 115 may include a feed roller 122 to assist with feeding the feed material into the reduction chamber.

The engine may drive the rotor 112 using, for example, a drive belt or the like. The engine may drive the rotor 112 in either a clockwise (downswing) or a counter clockwise (upswing) rotational direction, depending upon the particular application and configuration of the wood chipper 100.

The wood chipper 100 also includes a discharge chute 125 through which processed material is discharged/ejected from the system 100. The processed material typically falls and collects on the ground for subsequent handling or may be deposited into a dump truck or the like for transportation. In some cases, the discharge chute 125 may be configured to fold or otherwise adjust in shape, either for directing the flow of the discharge or for ease in transportation.

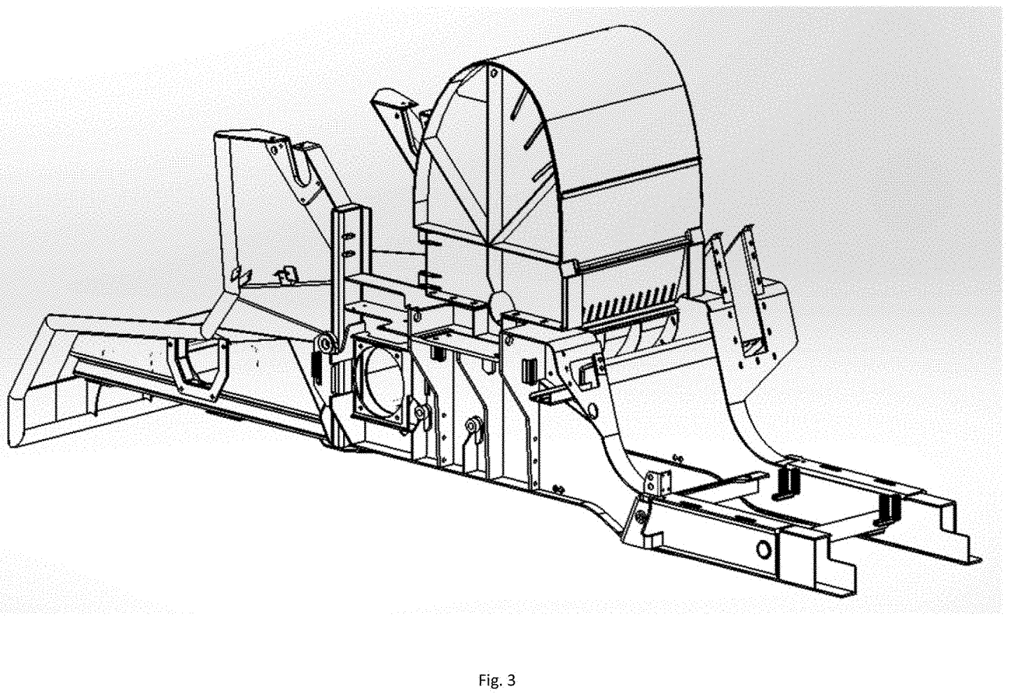

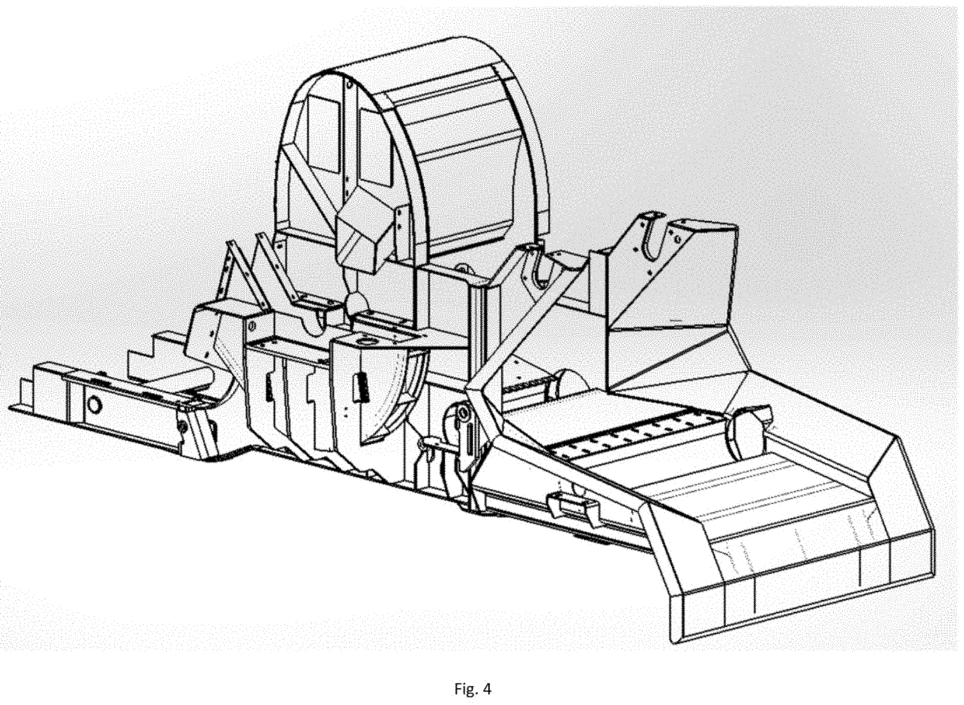

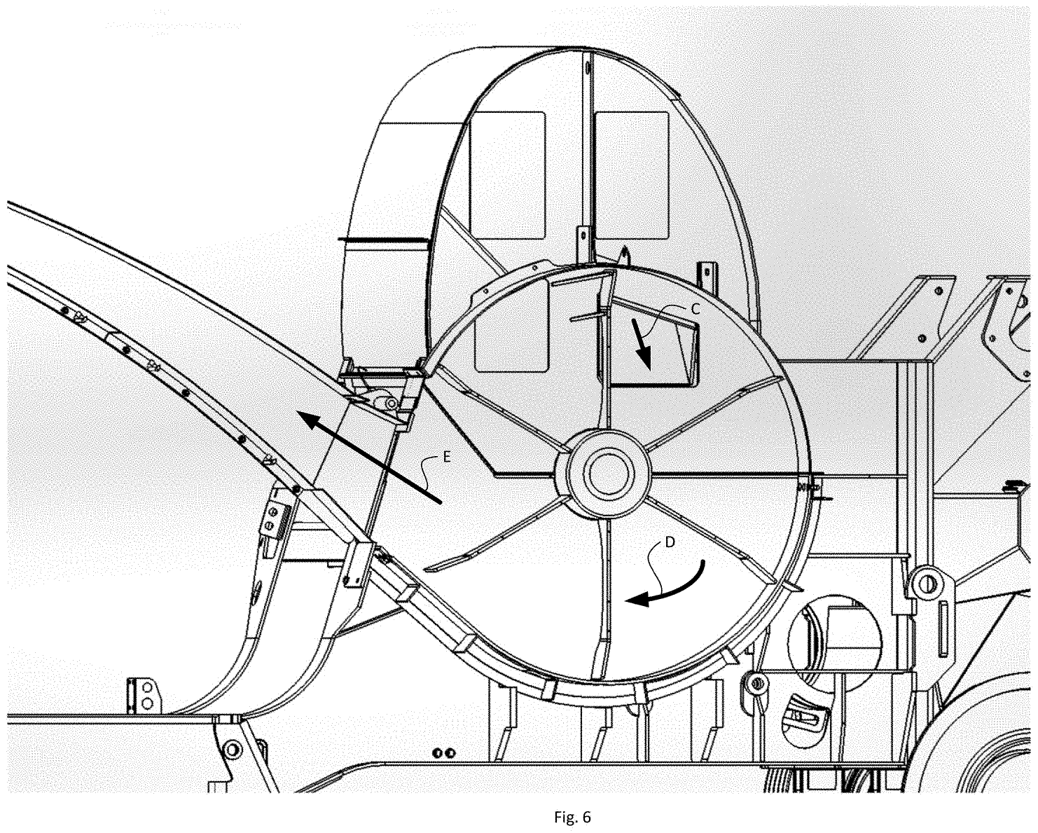

FIGS. 3 and 4 illustrate a discharge chamber 130 that is positioned generally above the reduction chamber 114 and has a generally elliptical shape when viewed from the side. FIG. 5 is a cut-away showing the interior of the discharge chamber 130 and the reduction chamber 114. FIG. 6 is a cut-away view showing the configuration of a fan 135 provided to the side of the discharge chamber 130.

As seen in FIG. 5, the rotor 112 is accommodated within the reduction chamber 114. The feed material enters the reduction chamber 114, is comminuted by the rotor 112 within the reduction chamber 114, and passes through a framework 137 that can further comminute the reduced material as it exits from the reduction chamber 114. The comminuted material is drawn up into a first section 140 of the discharge chamber 130 by the pressure created by rotation of the fan 135. As the comminuted material is drawn upward in the discharge chamber 114, the comminuted material is guided by a curved external wall 145 and an upwardly sloping internal wall 150 of the discharge chamber 114, as illustrated by arrow A. The comminuted material then passes into a second section 155 of the discharge chamber, where the comminuted material continues to follow the curved exterior wall 145 of the discharge chamber and is drawn down a sloped internal structure 160 to direct the comminuted material toward an opening 165 in the discharge chamber 114 into the fan 135, as illustrated by arrow B.

As shown in FIG. 6, the fan includes a plurality of blades, which, when turning, draw air through the opening 165 in the discharge chamber and generate pressure to draw the comminuted material through the discharge chamber and into the fan, as illustrated by arrow C in FIG. 6. The plurality of blades also collect the comminuted material from the discharge chamber and push the comminuted material into the discharge chute, as illustrated by arrows D and E. The pressure imparted by the plurality of blades conveys the comminuted material along the length of the discharge chute where the comminuted material is discharged.

In this embodiment, the fan is mounted on the same shaft as the rotor and, as such, is driven by the same engine as the rotor. This arrangement eliminates any need for a separate engine to drive the fan.

While the discharge chamber could have a different shape, the elliptical shape of the discharge chamber generally assists with the flow of the comminuted material through the discharge chamber.

The fan and the plurality of blades therein are configured to provide enough pressure to draw the comminuted material through the discharge chamber and then discharge the comminuted material through the discharge chute. In tests conducted using a prototype system, the comminuted material was discharged a significant distance from the system but this can be adjusted by configuring the fan, discharge chute and the like.

The discharge chamber and fan can be included in a system for discharge according to an embodiment herein. A method of discharge according to an embodiment herein can include providing the discharge chamber and the fan and the flow indicated by the arrows in FIGS. 5 and 6. In some cases, the system and method may include the discharge chute as well.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether the embodiments or elements thereof described herein are implemented as a software routine, hardware circuit, firmware, or a combination thereof.

The above-described embodiments are intended to be examples only. Alterations, modifications and variations can be effected to the particular embodiments by those of skill in the art without departing from the scope, which is defined solely by the claims appended hereto.

What is claimed is:

1. A wood chipper and system and method for discharge as both generally and specifically described herein.
